(19) United States
(12) Patent Application Publication
(10) Pub. No.: US 2005/0132038 A1
(43) Pub. Date: Jun. 16, 2005

(54) Resource reservation system and resource reservation method and recording medium storing program for executing the method

(76) Inventors: Hiroshi Inoue, Yokohama-shi (JP); Takao Moriyama, Yokohama-shi (JP); Yasushi Negishi, Tokyo-to (JP); Moriyoshi Ohara, Yokohama-shi (JP)

Correspondence Address: Ido Tuchman, Suite 503, 69-60 108th Street, Forest Hills, NY, 11375, US

(21) Appl. No.: 10/998,237

(22) Filed: Nov. 27, 2004

(30) Foreign Application Priority Data
Nov. 28, 2003 (JP) JP2003-398823

(51) Int. Cl. G06F 15/173

(52) U.S. Cl. 709/223

(57) ABSTRACT

A system, method and computer program product for guaranteeing a process requesting a predetermined amount of calculation of a calculation resource that a predetermined amount of calculation is obtained by a deadline. The invention includes measuring an amount of calculation of the process obtained through calculation processing by the calculation resource, generating an interrupt to the calculation processing using the calculation resource and acquiring the amount of calculation acquired by an interrupt generation time, providing the amount of calculation acquired to the calculation resource so as to calculate a slack time and determining whether said slack time is available or not, and interrupting the processing of other processes by said calculation resource if the slack time is not available.

### CROSS-REFERENCE TO RELATED APPLICATIONS

This application claims priority to Japanese Patent Application No. JP2003-398823 filed Nov. 28, 2003, the entire text of which is specifically incorporated by reference herein.

### FIELD OF THE INVENTION

The present invention relates to a system, method and recording medium capable of guaranteeing assignment of calculation resources to which simultaneous multithread (SMT) technology is applied to a real-time process, giving as many calculation resources as possible to a non-real-time process at the same time and thereby improving the throughput of the entire system.

### BACKGROUND

A real time operating system (real-time OS) may include functionality to ensure that an event handler, such as an interrupt service routine started by an external interrupt, corresponding of the event is started within a predetermined time period. For example, during file input/output or screen drawings processing a supply voltage or a sensor error may occur, causing an interrupt service routine to start within several microseconds to milliseconds for applications requiring real-time processing of an event. Such a real-time OS is a preemptive multitask OS created with importance attached to a real-time processing capacity and is preferably used for applications required to start an event handler and carry out processing the moment an event occurs.

One of requirements for a real-time OS is to guarantee an amount of processing per a unit time of a process in a system. Conventionally, a real-time system provided with a real-time OS is often used for built-in applications and its processes in the system are often fixed. For this reason, the necessary processing performance is secured by carefully setting a priority relationship in a group of processes and causing the processes to cooperate with one another. However, even the built-in system is becoming a substantially open type system. It is becoming increasingly difficult to predicatively understand the type and behavior of an application operating under the system.

In response, there is a proposal on a resource reservation type system. This resource reservation type system reserves an execution time of a calculation resource, such as a central processing unit (CPU), with a maximum value of the calculation time necessary to achieve a required amount of processing for a real-time process having a deadline and can thereby reliably satisfy a demand by the deadline.

However, in simultaneous multithread (SMT) technology that allows a plurality of threads to operate simultaneously on a single CPU, the amount of calculation that the CPU can execute within a certain time varies a great deal under the influence of other threads (hereinafter referred to as “back processor thread”) operating simultaneously on the same CPU. As a result, in an environment in which SMT technology is applied, there is a problem that it is not possible to obtain a scheduled amount of calculation despite the fact that a necessary calculation time is reserved through a reservation of the calculation resource. Note that the above-described thread is basic unit whereby the operating system (OS) assigns execution times of the CPU and one or more threads are generated in a process, which is a unit that OS controls a program.

One possible method to solve the above described problem is a method which disables the SMT function, preventing executions of the back processor threads which are simultaneously operating on a single CPU when a real-time process is in progress in order to obtain a scheduled amount of calculation. However, this method has a problem of wasting the characteristic of SMT improving the system throughput by simultaneously executing processes.

Furthermore, one example of a system that solves the above described problem is TimeSys Linux/RT by TimeSys Corporation. This real-time OS provides a reservation function of a calculation time corresponding to a multiprocessor system. However, this reservation function does not take SMT into consideration and involves a problem that the calculation rate of the CPU varies in an unpredictable manner on a system using SMT and reserving execution times of the CPU makes it impossible to guarantee the calculation performance.

Hiroshi Inoue et al., “CPU Resource Reservation in System Using SMT”, Japan Society for Software Science and Technology, 6th Workshop About Systems for Programming and Applications, Mar. 12 to 14, 2003, discloses that it is not possible to secure an amount of calculation scheduled in an environment in which the above described reservation function uses SMT and has proposed to let back processor threads to be simultaneously executed to sit idle when a reserved process is in progress or to execute other processes which always fall under the same combination with the reserved process as a method for solving this problem.

Jain. R., Hughes. C. J., Adve. S. V. “Soft Real—Time Scheduling on Simultaneous Multithreaded Processors,” 23rd IEEE Real—Time Systems Symposium, Dec. 3-5, 2002 proposes, as another method for solving the problem, scheduling of a soft real-time process in an environment in which SMT is used. Scheduling is performed by selecting processes on which simultaneously executing a combination of real-time tasks has little influence.

However, in the method whereby when the above described reserved process is in progress, back processor threads to be simultaneously executed are left idle or processes are always executed in the same combination. Idling means that the SMT function is not fully utilized. Furthermore, processes that must always be executed in the same combination involves a problem that it is not applicable to a system in which other unknown processes are mixed. In addition, scheduling of soft real-time processes on a system using SMT tolerates deadline errors of 5% or less, resulting in a problem that it is not possible to reliably guarantee the amount of calculation by a deadline.

### SUMMARY OF THE INVENTION

The present invention is implemented in view of the above described problems to help guarantee a deadline of a real-time process on a CPU using SMT and at the same time processing other processes whenever possible to improve the system throughput. When a reserved process is dispatched to a calculation resource, a determination is made as to whether there is a slack time until a deadline. If so, another process is dispatched. The determination of slack time is made on an as-needed basis. The processor can continue other processes when there is a slack time and dispatch other processes when there is no slack time, to let operating back processor threads sit idle and allow the reserved processes to occupy calculation resources and thereby guarantee a predetermined amount of calculation by the deadline.

Thus, one exemplary aspect of the present invention is a calculation resource reservation system for guaranteeing a process requesting a predetermined amount of calculation of a calculation resource that the predetermined amount of calculation is obtained by a deadline. The calculation resource is configured to process a plurality of processes simultaneously. The calculating resource reservation system includes a measuring section configured to measure an amount of calculation of the process obtained through calculation processing by the calculation resource. A slack time decision section is configured to generate an interrupt to the calculation processing using said calculation resource, acquire the amount of calculation acquired by an interrupt generation time from said measuring section, provide the amount of calculation acquired to the calculation resource so as to calculate a slack time, and determine whether the slack time is available or not. A processing interruption section is configured to interrupt the processing of other processes by the calculation resource if the slack time decision section determines that the slack time is not available.

Another exemplary aspect of the invention is a calculation resource reservation method for guaranteeing a process requesting a predetermined amount of calculation of a calculation resource that the predetermined amount of calculation is obtained by a deadline. The method includes a measuring operation to measure an amount of calculation of the process obtained through calculation processing by the calculation resource. A generating operation is configured to generate an interrupt to the calculation processing using the calculation resource and acquire the amount of calculation acquired by an interrupt generation time. A providing operation offers the amount of calculation acquired to the calculation resource so as to calculate a slack time and determine whether the slack time is available or not. An interrupting operation interrupts the processing of other processes by the calculation resource if the slack time is not available.

Yet another exemplary aspect of the invention is a computer program product embodied in a tangible media. The computer program product is configured to cause a program to measure an amount of calculation of the process obtained through calculation processing by the calculation resource, generate an interrupt to the calculation processing and acquire the amount of calculation acquired by the interrupt generation time, calculate a slack time using the amount of calculation acquired and determine whether the slack time is available or not, and interrupt the processing of other processes by the calculation resource if the slack time is not available.

By providing a system, method and computer program product of the present invention, it is possible to use simultaneous multithread technology (SMT) to improve throughput while guaranteeing a deadline of a real-time process on a calculation resource such as a CPU through the reservation of the calculation resource.

### BRIEF DESCRIPTION OF THE DRAWINGS

FIG. 1 illustrates an embodiment of a system in which the calculation resource reservation system of the present invention is incorporated;

FIG. 2 illustrates one embodiment of the calculation resource reservation system of the present invention;

FIG. 3 is a flow chart illustrating a process of reservation of a calculation resource using the calculation resource reservation system shown in FIG. 2;

FIG. 4 shows another embodiment of the calculation resource reservation system of the present invention;

FIG. 5 is a flow chart illustrating a process of reservation of a calculation resource using the calculation resource reservation system shown in FIG. 4;

FIG. 6 shows a further embodiment of the calculation resource reservation system of the present invention;

FIG. 7 illustrates a process of reservation of a calculation resource using the calculation resource reservation system shown in FIG. 6;

FIG. 8 is a chart illustrating a timing at which an interrupt is generated when a processor which is a calculation resource processes a real-time process;

FIG. 9 is a chart illustrating a timing at which an interrupt is generated when a processor which is a calculation resource processes a real-time process;

FIG. 10 is a chart illustrating a timing at which an interrupt is generated when a processor which is a calculation resource processes a real-time process; and

FIG. 11 shows a comparison between the effect when the system of the present invention is used and the effect in the case of a conventional system, that is, the case where a real-time process and non-real-time process are simply processed simultaneously.

### DESCRIPTION OF REFERENCE NUMBERS

10 . . . System

20 . . . Television antenna

30 . . . Remote controller

40 . . . Video cassette recorder

41 . . . Processor

42 . . . Storage device

43 . . . Reception section

44 . . . Television tuner

50 . . . Display device

60 . . . Calculation resource reservation system

61 . . . Measuring section

62 . . . Slack time decision section

62a . . . Interrupt generation time setting section

62b . . . Amount of calculation decision section

63 . . . Processing interruption section

### DETAILED DESCRIPTION OF THE INVENTION

The present invention is explained according to specific embodiments shown in the attached drawings below, however, the present invention is not limited to those embodiments.

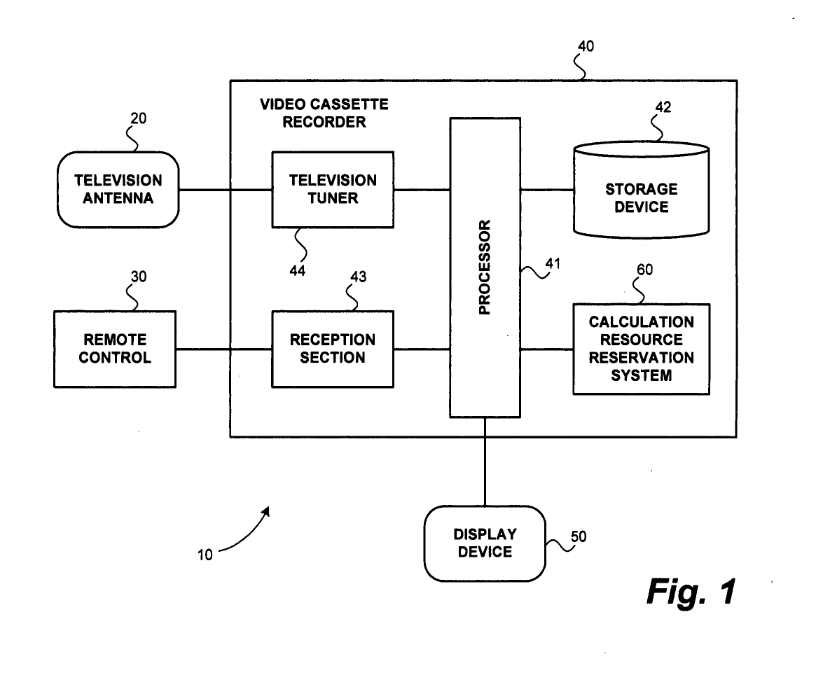

FIG. 1 illustrates an embodiment of an exemplary system 10 that incorporates a calculation resource reservation system according to the present invention. FIG. 1 shows the system 10 constructed of a television antenna 20, a remote controller 30, a video cassette recorder 40 and a display device 50. In the system 10 shown, the video cassette recorder 40 incorporates an embodiment of the calculation resource reservation system 60 of the present invention. In addition to the calculation resource reservation system 60, the video cassette recorder 40 also houses a processor 41 which is a calculation resource and an operating system (OS) which controls various resources and allows an application to use those resources and the application, and is provided with a storage device 42 for storing processing results, a reception section 43 which receives signals from the remote controller 30 and a television tuner 44 which receives image data and speech data through the television antenna 20. Here, “resources” refers to the processor 41, storage device 42, reception section 43, television tuner 44, etc.

In the embodiment shown in FIG. 1, image data and speech data received by the television tuner 44 is subjected to compression processing by the processor 41 and written to the storage device. This is processing called “recording.” Furthermore, the user also performs other operations using the remote controller 30 during recording. In one case, the processor 41 is also carrying out response processing for the user's operation simultaneously with the compression processing for recording. As the response processing for the user's operation, the processor 41 carries out, for example, channel change processing and displays the image of the changed channel on the display device 50.

The above described compression processing and channel change processing are executed using a process as one processing unit. Compression processing of arbitrary image and speech needs to be completed before the next image and speech data is received and if the compression processing is not completed before the next image and speech data is received, the data is lost. In the case of this processing, one process comprises data reception, compression processing and reception of the next data and this process has a deadline by which it must complete the processing before the next data is received. Therefore, this process is a real-time process. In contrast, the channel change processing is preferably processed as soon as possible, but since it has no deadline, the channel change processing can be performed with a certain delay. The process as a processing unit of this processing is a non-real-time process.

The calculation resource reservation system of the present invention is a system for guaranteeing assignment of calculation resources to the above described real-time process and at the same time performing scheduling so that as many calculation resources as possible are assigned to the above described non-real-time process. That is, it is a system for assigning processes and reserving calculation resources. More specifically, it is a system that checks the amount of calculation obtained for a real-time process as appropriate, obtains the remaining amount of calculation from the amount of calculation, calculates the remaining time until a deadline, decides whether there is a time space (referred to herein as “slack time”) or not from the remaining time and the remaining amount of calculation, interrupts the execution of threads in the non-real-time process when there is no slack time, and assigns all calculation resources to the real-time process to ensure that a predetermined amount of calculation is achieved by the deadline.

Referring to FIG. 1, when the user performs recording, in response to the event, the OS being executed on the processor 41 creates and controls calculations to be executed in “process” units. Furthermore, to subject this process to calculation processing, the OS performs dispatch for assigning the processor 41. Note that for the process, a deadline and a predetermined amount of calculation that should be achieved by the deadline are predetermined. Furthermore, a calculation time when no back processor thread for the predetermined amount of calculation is executed, that is, when the processor 41 is only assigned to this process, is also determined. The calculation resource reservation system 60 of the present invention decides whether there is a slack time or not when a process is dispatched, and can dispatch other processes such as channel change processing when there is a slack time.

Furthermore, the calculation resource reservation system 60 can generate an interrupt to interrupt calculation processing by the processor 41, causes the processor 41 to calculate a slack time, decide whether there is a slack time or not based on the calculation result, releases interrupts to the other processes when it decides that there is no slack time, only assigns the processor 41 to the above described process and guarantee that the amount of calculation can be achieved by a deadline. When the predetermined amount of calculation that should be achieved by the deadline is obtained, the processor 41 can be assigned to other processes from that time to the deadline.

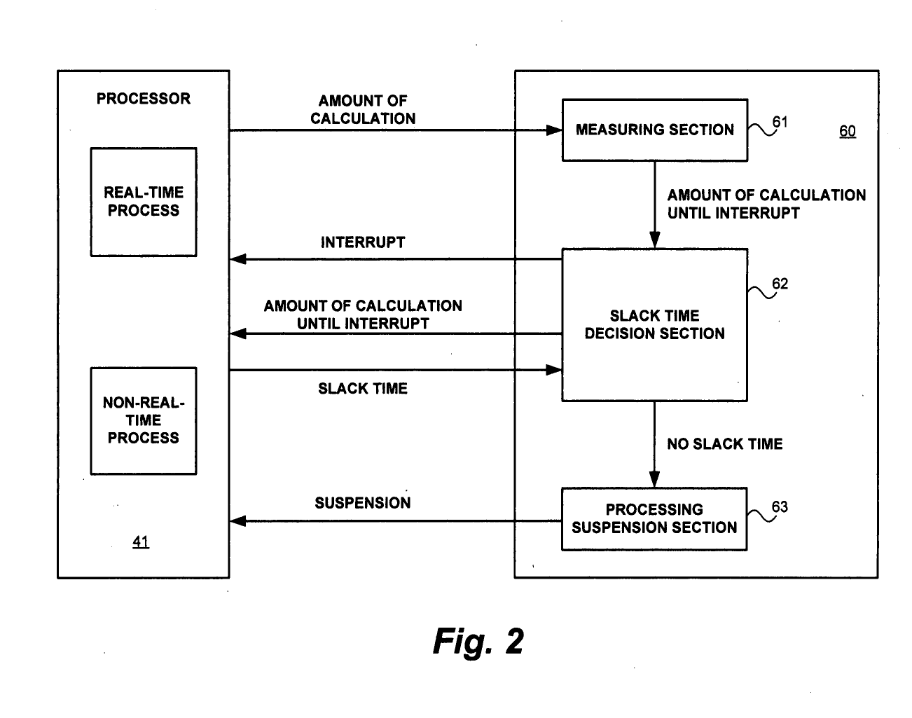

One embodiment of the calculation resource reservation system of the present invention will be explained with reference to FIG. 2. The exemplary calculation resource reservation system 60 shown in FIG. 2 guarantees a process (hereinafter referred to as “real-time process”) requesting a calculation resource which carries out a plurality of processes simultaneously to achieve a predetermined amount of calculation by a deadline that the predetermined amount of calculation is achieved by the deadline. The calculation resource reservation system 60 is constructed of a measuring section 61, a slack time decision section 62 and a processing interruption section 63. The measuring section 61 measures an amount of calculation of a real-time process obtained through the calculation processing by the processor 41 which is a calculation resource. The slack time decision section 62 causes the processor 41 to generate an interrupt to the calculation processing, acquires an amount of calculation from the measuring section 61 at the time at which the interrupt is generated (interrupt generation time), and gives the acquired amount of calculation to the processor 41, so as to calculate a slack time and decide whether there is a slack time or not based on the result. Note that an interrupt is executed by sending an interrupt signal to the processor 41 and interrupting the process of the processor 41. Furthermore, an interrupt can be generated at certain time intervals or generated at an arbitrary time. When the slack time decision section 62 decides that there is no slack time, the processing interruption section 63 interrupts the calculation processing of other processes being executed simultaneously.

A real-time process having a deadline is assigned by the OS to the processor 41 and the processing is started by the processor 41. In FIG. 2, a real-time process and a non-real-time process are processed simultaneously. The measuring section 61 can measure an amount of calculation of the real-time process from the time at which the processor 41 starts to process the real-time process and provide an amount of calculation at an arbitrary time on demand. The embodiment shown in FIG. 2 is designed to provide an amount of calculation obtained by the time of an interrupt generated at certain time intervals. The present invention can also be adapted so that a program to be executed in the processor 41 is constructed to measure the amount of calculation concurrently with the processing of a real-time process and the amount of calculation is measured by executing the program. Furthermore, it is also possible to measure the amount of calculation using a performance monitor of the processor 41. In constructing the program, it is possible to construct the program so that in response to the generation of an interrupt, the amount of calculation obtained by the interrupt generation time is notified.

In the embodiment shown in FIG. 2, the slack time decision section 62 is set so as to generate an interrupt at certain time intervals. An interrupt is executed by giving an interrupt signal to the processor 41 in calculation processing. When an interrupt is generated, the processor 41 stops calculation processing. During this interrupt, an amount of calculation obtained until the interrupt generation time is acquired from the measuring section 61. The present invention can also be adapted in such a way that in response to a generated interrupt, the measuring section 61 is notified and acquires an amount of calculation obtained by that time. It is contemplated that an interrupt can be generated using a system timer or external timer mounted on the OS. When a system timer is used, an interrupt is generated at certain time intervals and when an external timer is used, an interrupt can be generated at variable time intervals.

Furthermore, during the interrupt, the slack time decision section 62 gives the amount of calculation acquired from the measuring section 61 to the processor 41, causes the processor 41 to calculate the slack time and decides whether there is a slack time or not from this result. Note that a slack time tₛ can be calculated by the formula, tₛ=(t_{d}−t₀)−(cᵣ−c₀).

t_{d} is a deadline, t₀ is an interrupt generation time, cᵣ is a predetermined amount of calculation represented by the calculation time when there is no influence of a back processor thread (that is, the value of a predetermined amount of calculation when no back processor thread is executed on the value processor 41 expressed as a calculation time), c₀ is an amount of calculation obtained by the time t₀ represented by a calculation time when there is no influence of the back processor thread as in the case of cᵣ. For example, c₀ can be calculated by calculating a value of amount of calculation/calculation time from a predetermined amount of calculation and a predetermined calculation time corresponding to the predetermined amount of calculation and using this value and the measured amount of calculation. A unit for this calculation time is, for example, ms (millisecond). A slack time is a value obtained by subtracting a remaining calculation time to be obtained from the remaining time until the above described deadline. The slack time decision section 62 decides whether the calculated slack time is 0 or exceeds 0. When the slack time is 0, this means that unless the processor 41 is only assigned to the real-time process, it is not possible to acquire the predetermined amount of calculation by the deadline and when the slack time exceeds 0, the processor 41 can still be assigned to other processes (hereinafter referred to as “non-real-time processes”).

When the slack time decision section 62 decides that there is no slack time, the processor 41 should only be assigned to the real-time process, and therefore the processing interruption section 63 suspends non-real-time processes being processed on the processor 41. When the processor 41 is also carrying out another process, that process is also suspended. As described above, this allows the processor 41 to be assigned to only the real-time process and ensures that the amount of calculation to be acquired by the deadline is acquired. In reality, since threads are being executed on the processor 41, they can be suspended by letting the back processor threads of the non-real-time processes sit idle. Note that the suspended state of the suspended non-real-time processes, that is, context is stored in a storage section (not shown) such as a cache. The context refers to an internal state of a program or a situation in which the program is placed or given condition, etc., which becomes material for making a decision when the program being executed selects the processing content, and, for example, when an operator or function which can take a plurality of types of arguments selects a type of a return value according to the type of each argument, the context is the type of the argument when the operator or function is invoked. In the present invention, when the real-time process is completed by a deadline, by releasing the assignment of the processor to the real-time process, the processor 41 can read the context from the storage section (not shown) and start processing from the state in which the non-real-time process was suspended.

Furthermore, when the slack time decision section 62 decides that the slack time exceeds 0, an interrupt is generated again a certain time later, the amount of calculation obtained so far is acquired and given to the processor 41 so as to calculate a slack time and decide whether the slack time is 0 or not based on this result. By repeating this, it is possible to guarantee the deadline of the real-time process and at the same time also assign calculation resources to non-real-time processes effectively and thereby improve the system throughput. Note that an interrupt by the slack time decision section 62 is by far smaller than a processing time of one process. Furthermore, the amount of calculation is acquired and the slack time is calculated within this interrupt time.

When the slack time decision section 62 generates an interrupt at certain time intervals, the slack time calculated by the processor 41 may become a negative value. When the slack time becomes a negative value, this means that even if the processor 41 is only assigned to the real-time process, it is not possible to obtain an amount of calculation to be obtained by the deadline. Therefore, the present invention can shorten time intervals of interrupt generation and provides the slack time with a threshold to decide whether the slack time exceeds, for example, 0.01 ms or not so as to guarantee the deadline of the real-time process. Functions such as a calculation of the slack time, decision as to whether there is a slack time or not and suspension of other processes can also be realized by including the functions in an interrupt handler which is an executable code sent to the processor 41 during an interrupt and causing the processor 41 to execute this handler.

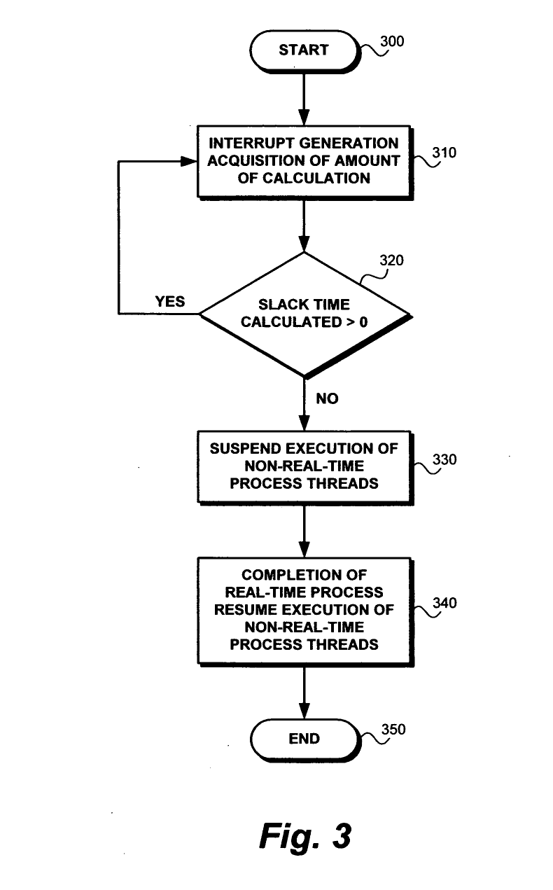

FIG. 3 is a flow chart showing a process of reserving a calculation resource using the calculation resource reservation system shown in FIG. 2. First, a real-time process is started by being dispatched by the processor which is a calculation resource (step 300). After a lapse of a certain time, an interrupt is generated and an amount of calculation of the real-time process obtained by the interrupt generation time is acquired (step 310). The acquired amount of calculation is given to the processor so as to calculate a slack time and decides whether there is a slack time or not (step 320). When it is decided that there is a slack time, the process moves back to step 310, an interrupt is generated after a lapse of a next certain time to acquire an amount of calculation obtained after the process start time to the next interrupt generation time. When it is decided that there is no slack time in step 320, the execution of back processor threads being executed on the processor is suspended (step 330). In this way, it is possible to assign the processor to only the real-time process and reliably acquire the amount of calculation to be acquired by the deadline. Furthermore, when the real-time process is completed, it is possible to resume processing on non-real-time processes (step 340). After the deadline is reached, if the real-time process is dispatched to the processor, processing in steps 300 to 340 can be performed again. If the real-time process is not dispatched, the processing by the processor is completed when the non-real-time process is completed (step 350).

One embodiment of the present invention can also include a step of causing the processor to calculate a slack time at the time of dispatch, deciding whether there is a slack time or not and dispatching the non-real-time process when there is a slack time. In this case, it is possible to include the above-described dispatching step between step 300 and step 310.

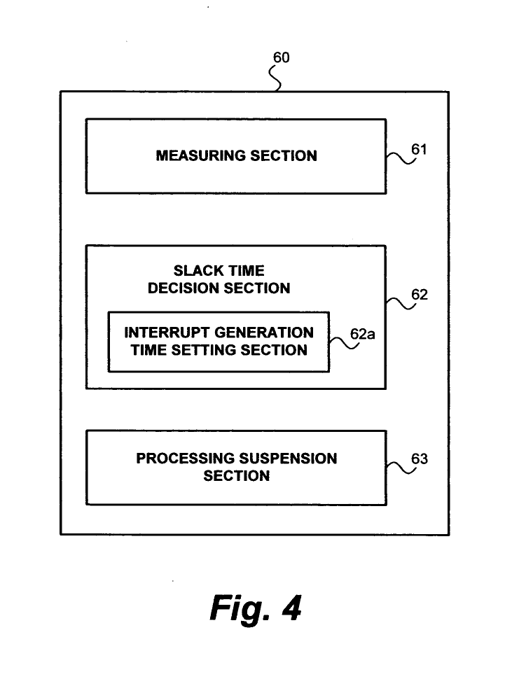

FIG. 4 shows another embodiment of a calculation resource reservation system of the present invention. The system shown in FIG. 4 is a system that can calculate a time at which an interrupt is generated, generate the interrupt at that time and acquire an amount of calculation at that time. The system shown in FIG. 4 includes an interrupt generation time setting section 62a that causes, when the slack time decision section 62 decides that there is a slack time, the processor to calculate the next interrupt generation time using the slack time and interrupt generation time and sets the next interrupt generation time so that an interrupt is generated at the calculated next interrupt generation time.

The interrupt generation time setting section 62a causes the processor 41 to calculate the next interrupt generation time tₙ using a deadline, amount of calculation to be obtained by the deadline, interrupt generation time, amount of calculation obtained by the interrupt generation time and the formula, tₙ=(t_{d}−t₀)−(cᵣ−c₀)+t₀.

t_{d} is a deadline, to is an interrupt generation time, cᵣ is a value of a predetermined amount of calculation expressed by a calculation time when there is no influence of the back processor threads and c₀ is a value of an amount of calculation obtained until t₀ expressed by a calculation time when there is no influence of the back processor threads. Note that this tₙ is the sum of t₀ and slack time. During the period from t₀ to tₙ, even when no amount of calculation is obtained, the slack time only decreases and the slack time exists in this period, and therefore generating an interrupt in this period goes to waste. The interrupt generation time setting section 62a causes the processor 41 to calculate the time at which the slack time becomes 0, that is, tₙ when no amount of calculation is obtained using the above described formula, sets it in the slack time decision section 62 so that an interrupt is generated at the time obtained and prevent any unnecessary interrupt from being generated. When no amount of calculation is obtained in the period from t₀ to tₙ, it is possible to let the back processor thread sit idle at time tₙ, only assign the processor 41 to the real-time process and acquire a predetermined amount of calculation to be acquired by a deadline. Using this interrupt generation time setting section 62a, it is possible to reduce the number of times interrupts are generated and carryout processing more efficiently. This function can also be included in the aforementioned interrupt handler and realized by causing the processor 41 to execute this handler.

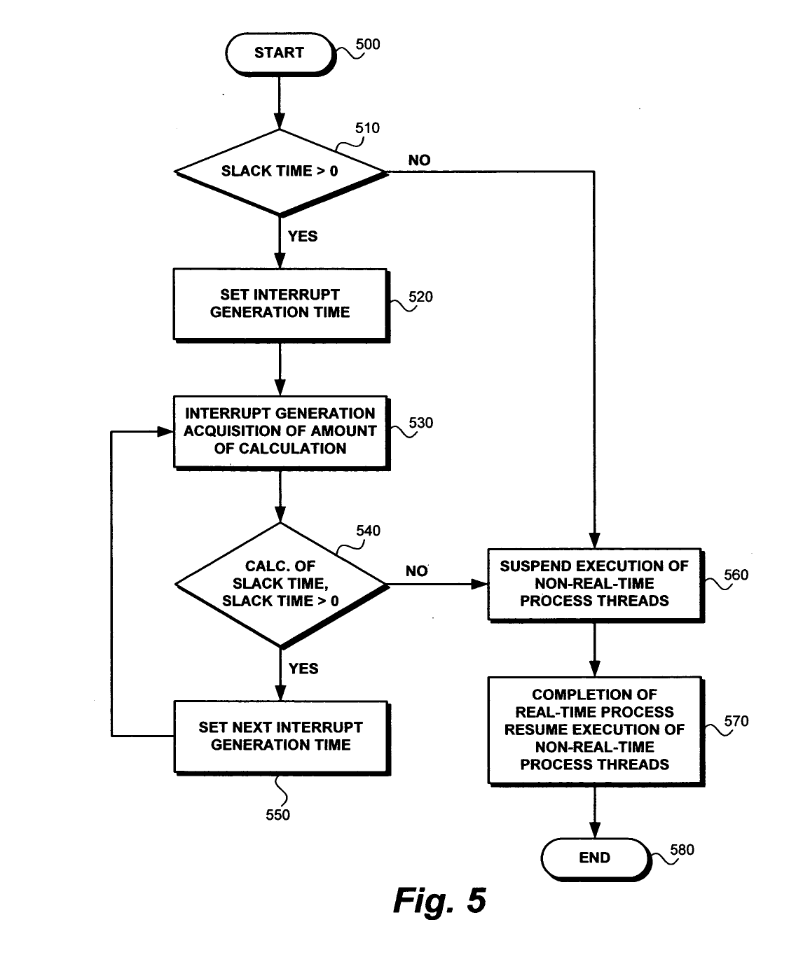

FIG. 5 is a flow chart showing a process of reserving a calculation resource using the calculation resource reservation system shown in FIG. 4. First, a real-time process is started by being dispatched by the processor that is a calculation resource (step 500). When the real-time process is dispatched, the processor calculates a slack time and decides whether there is a slack time or not (step 510). The slack time in this case can be calculated from the formula tₙ=(t_{d}−t₀)−(cᵣ−c₀)+t₀, assuming that the interrupt generation time is 0 and the amount of calculation expressed with a calculation time when there is no influence of the back processor thread is 0. When it is decided in step 510 that there is a slack time, the interrupt generation time is calculated and the interrupt generation time is set at the time obtained (step 520). An interrupt is generated at the interrupt generation time and the amount of calculation obtained by the interrupt generation time is acquired (step 530). Based on this acquired amount of calculation, the processor calculates the slack time and decides whether there is a slack time or not (step 540).

When it is decided in step 540 that there is a slack time, a next interrupt generation time is calculated and the next interrupt generation time is set at the time acquired (step 550). Returning to step 530, a next interrupt is generated and an amount of calculation is acquired. When it is decided in step 510 there is no slack time, the execution of threads of non-real-time processes is suspended (step 560) and the processor is only assigned to the real-time process. Furthermore, when it is decided in step 540 there is no slack time, the execution of back processor threads is suspended (step 560) and the processor is only assigned to the real-time process. When the real-time process is completed, the processing of the non-real-time process can be resumed (step 570). After the deadline is reached, if the real-time process is dispatched to the processor, the processing in steps 500 to 570 can be performed again. When the real-time process is not dispatched, the processing by the processor is completed when the non-real-time process is completed (step 580).

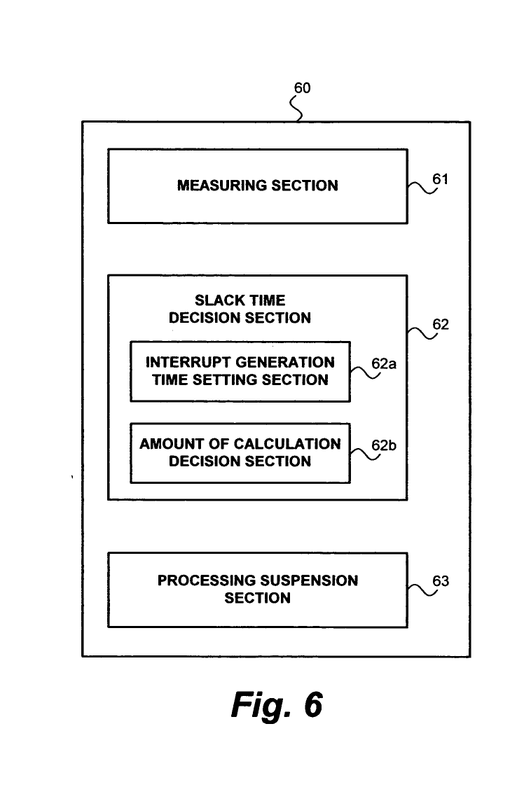

FIG. 6 shows a further embodiment of the calculation resource reservation system of the present invention. The system shown in FIG. 6 is a system that can calculate an interrupt generation time, acquire the amount of calculation at that time and decide whether the predetermined amount of calculation can be obtained before the interrupt generation time or not. In the system shown in FIG. 6, the slack time decision section 62 is constructed so as to further include an amount of calculation decision section 62b and when this amount of calculation decision section 62b decides that the predetermined amount of calculation can be obtained before the interrupt time, it is possible to assign the processor occupied by the real-time process to the non-real-time process to promote the processing of the non-real-time process. Adopting such a structure can further improve the system throughput.

To check the slack time, the interrupt generation time setting section 62a calculates a next interrupt generation time. The measuring section 61 measures the amount of calculation of the real-time process. When the measuring section 61 detects the completion of the real-time process, the amount of calculation decision section 62b responds to the detection, decides that the predetermined amount of calculation is obtained before the interrupt generation time, notifies it to the slack time decision section 62 and cancels the interrupt. In this case, it is possible to release the assignment of resources to the real-time process, assign the resources to the non-real-time process, and the processor can execute the back processor thread of the non-real-time process. When it is decided that the predetermined amount of calculation could not be obtained before the interrupt generation time, there is no notification to the slack time decision section 62 and the slack time decision section 62 generates an interrupt at the time set by the interrupt generation time setting section 62a. This function can also be realized by being included in the aforementioned interrupt handler and causing the processor 41 to execute this handler.

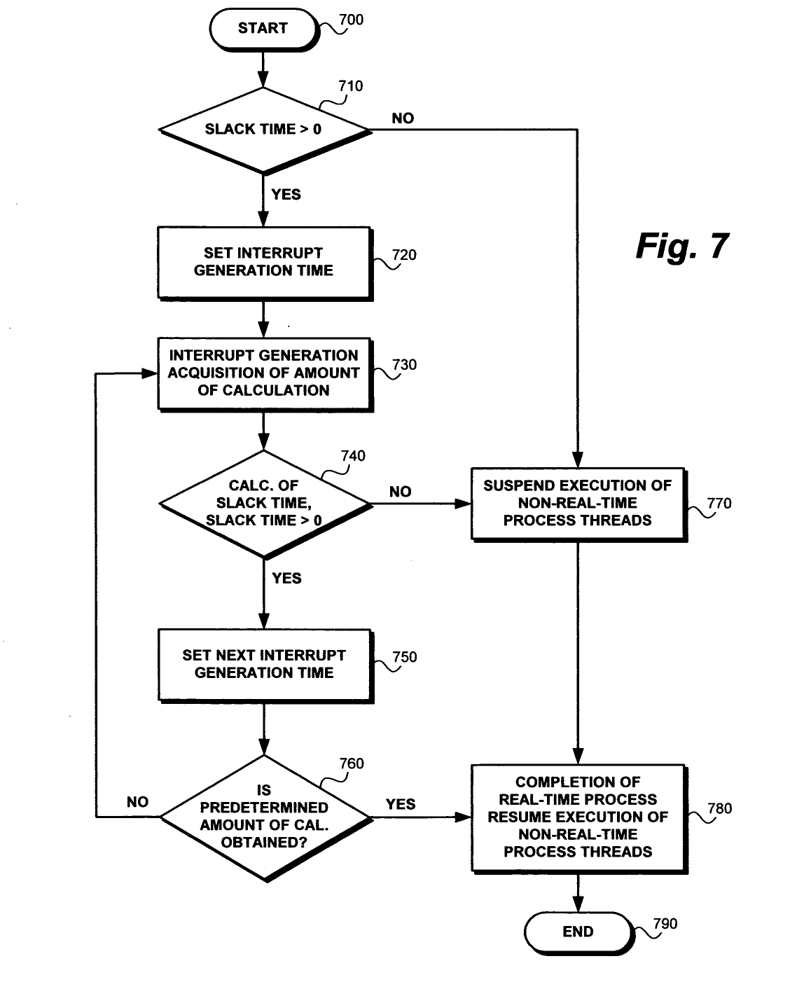

FIG. 7 is flow chart showing a process of reserving calculation resources using the calculation resource reservation system shown in FIG. 6. First, a real-time process is started by being dispatched to the processor which is a calculation resource (step 700). When the real-time process is dispatched, a slack time is calculated and it is decided whether there is a slack time or not (step 710). When it is decided that there is a slack time, an interrupt generation time is calculated and the interrupt generation time is set (step 720). When the interrupt generation time is reached, an interrupt is generated and the amount of calculation obtained by the interrupt generation time is acquired (step 730). Based on this acquired amount of calculation, a slack time is calculated and it is decided whether there is a slack time or not (step 740). When it is decided in step 740 that there is a slack time, a next interrupt generation time is calculated (step 750). It is decided whether the predetermined amount of calculation to be obtained could be obtained before the calculated next interrupt generation time or not (step 760). When it is decided that the predetermined amount of calculation could not be obtained, the process returns to step 730 and the next interrupt is executed based on the interrupt generation time calculated in step 750.

When it is decided in step 710 and step 740 that there is no slack time, the execution of the thread of the non-real-time process is suspended (step 770) and the processor is only assigned to the real-time process. Furthermore, when it is decided in step 760 that the predetermined amount of calculation could be obtained before the interrupt generation time, the assignment to the resources to the real-time process is released, the resources are assigned to the non-real-time processes and the processing of the non-real-time processes is resumed (step 780). After the deadline is reached, if the real-time process is dispatched to the processor, it is possible to carry out the processing in steps 700 to 780 again. When the real-time process is not dispatched, the processing by the processor is completed when the non-real-time process is completed (step 790).

The present invention can further reduce the number of times interrupts are generated using a minimum guaranteed value of assignment of calculation resources to the real-time process. This can be adopted when it is known that minimum guaranteed calculation performance can be obtained even when the non-real-time process is assigned to the calculation resources. In this case, the interrupt generation time setting section 62a can calculate a next interrupt generation time tₙusing the formula, tₙ=[(t_{d}−t₀)−(cᵣ−c₀)]/(1−α)+t₀.

t_{d} is a deadline, to is an interrupt generation time, cᵣ is the value of a predetermined amount of calculation represented by a calculation time when there is no influence of the back processor thread and c₀ is the value of an amount of calculation acquired at time to represented by a calculation time when there is no influence of the back processor thread. Furthermore, α is a minimum guaranteed value and is also the value of a minimum guaranteed amount of calculation performance obtained when a non-real-time process is processed represented by a ratio with respect to the calculation performance obtained when the non-real-time process is not processed and takes a value within a range of 0 or above and less than 1. When α is a value close to 1, this means that substantially no non-real-time process is carried out and there is substantially no influence of the non-real-time process compared to the processing of the real-time process. On the contrary, when α is 0, this means that the entire processor is occupied by the non-real-time process and the real-time process is not processed at all.

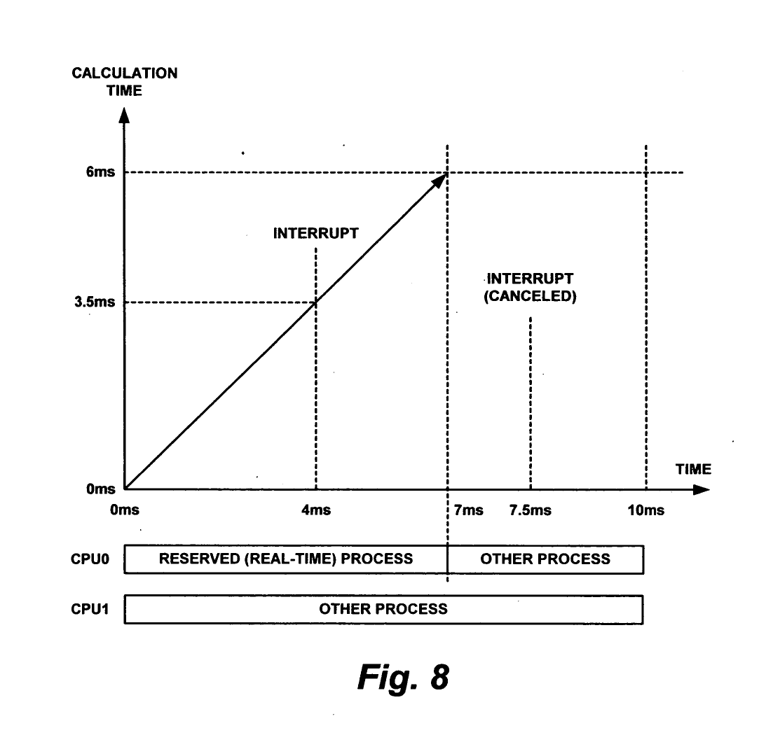

The reservation of the calculation resource using the calculation resource reservation system of the present invention will be explained in detail. FIG. 8 to FIG. 10 are timing charts obtained when the system shown in FIG. 4 or FIG. 6 is adopted. In FIG. 8 to FIG. 10, the assignment to the real-time process is represented by CPU0 and the assignment to the non-real-time process is represented by CPU1. Furthermore, the amount of calculation will be explained using the value represented by the calculation time when there is no influence of the back processor thread, that is, calculation time. FIG. 8 is a first embodiment showing a timing of generating an interrupt when the processor which is a calculation resource processes a real-time process. The vertical axis in FIG. 8 shows a calculation time (ms) which is an amount of calculation represented by a calculation time when there is no influence of the back processor thread and the horizontal axis shows a time (ms). In the embodiment shown in FIG. 8, a reserved process which is the real-time process reserves a calculation time corresponding to 6 ms by a deadline 10 ms later. At time 0, the real-time process is dispatched to the processor and at the same time as this real-time process is processed; other processes that are non-real-time processes are also dispatched.

First, at time 0, the slack time is calculated. Since it is time 0 and the calculation time is also 0, slack time 4 ms is calculated from the above described formula tₛ=(t_{d}−t₀)−(cᵣ−c₀). Since there is a slack time, the back processor thread is not left idle and an interrupt is generated at time 4 ms. As described above, this interrupt is executed to acquire a calculation time at time 4 ms. The embodiment shown in FIG. 8 shows that a calculation time of 3.5 ms is obtained by an interrupt. Since a calculation time of 3.5 ms is obtained at time 4 ms, the remaining calculation time is 2.5 ms and since there remains 6 ms until the deadline, there is a slack time of 3.5 ms. This slack time of 3.5 ms can be calculated from the above described formula tₛ=(t_{d} −t₀)−(cᵣ−c₀) and when the time for the next interrupt generation is calculated, it is time 7.5 ms.

In the embodiment shown in FIG. 8, it is possible to obtain the calculation time reserved at time 7 ms, and therefore an interrupt at time 7.5 ms is canceled. Furthermore, when the reserved calculation time can be obtained by time 7 ms, the remaining calculation time of 3 ms until the deadline can be assigned to other processes.

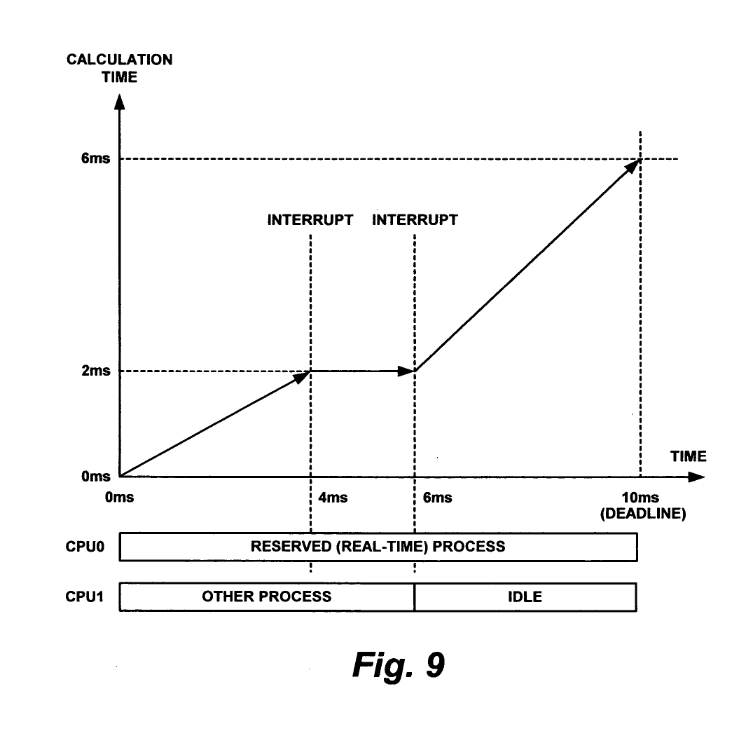

FIG. 9 is a second embodiment showing timing for generating an interrupt when the processor that is a calculation resource processes a real-time process. As in the case of FIG. 8, the vertical axis shows a calculation time (ms) and the horizontal axis shows a time (ms). As in the case of the embodiment shown in FIG. 8, this also shows that the reserved process reserves a time of 6 ms by the deadline 10 ms later. Furthermore, the processor is occupied by the reserved process and other processes. As in the case of the embodiment shown in FIG. 8, assuming that the time at which the reserved process is dispatched by the processor is 0, the slack time is calculated at time 0. As described above, since the calculation time at time 0 is also 0, the slack time is calculated as 4 ms from the above described formula tₛ=(t_{d}−t₀)−(cᵣ−c₀). Since there is a slack time, then the interrupt generation time is calculated using the above described formula tₙ=(t_{d}−t₀)−(cᵣ—c₀)+t₀. In this case, the interrupt generation time is calculated as 4 ms after the starting time of the reserved process. Therefore, an interrupt is generated at time 4 ms and a calculation time at time 4 ms is acquired.

FIG. 9 shows that only a calculation time of 2 ms is obtained at time 4 ms with respect to a calculation time of 6 ms. This calculation time of 2 ms is acquired and the slack time is calculated again. At this time, since there remains a time of 6 ms until the deadline and the remaining calculation time is 4 ms, the slack time is calculated as 2 ms from the above described formula tₛ=(t_{d}−t₀)−(cᵣ−c₀). Since the slack time exceeds 0, the next interrupt generation time is calculated. In this case, from the above described formula tₙ=(t_{d}−t₀)−(cᵣ−c₀)+t₀, the next interrupt generation time is calculated as time 6 ms. At time 6 ms, an interrupt is generated to acquire the calculation time. In the embodiment shown in FIG. 9, no reserved process is processed for a period from time 4 ms to time 6 ms, only a calculation time of 2 ms is obtained at time 6 ms. The slack time is calculated again and since the time until the deadline is 4 ms with respect to the remaining calculation time of 4 ms, 0 is calculated as a slack time. To obtain the reserved calculation time by the deadline, it is necessary to only assign the reserved process to the processor and when the slack time is calculated as 0, other processes being simultaneously processed are left idle. This makes it possible to obtain the reserved calculation time of the reserved process by the deadline.

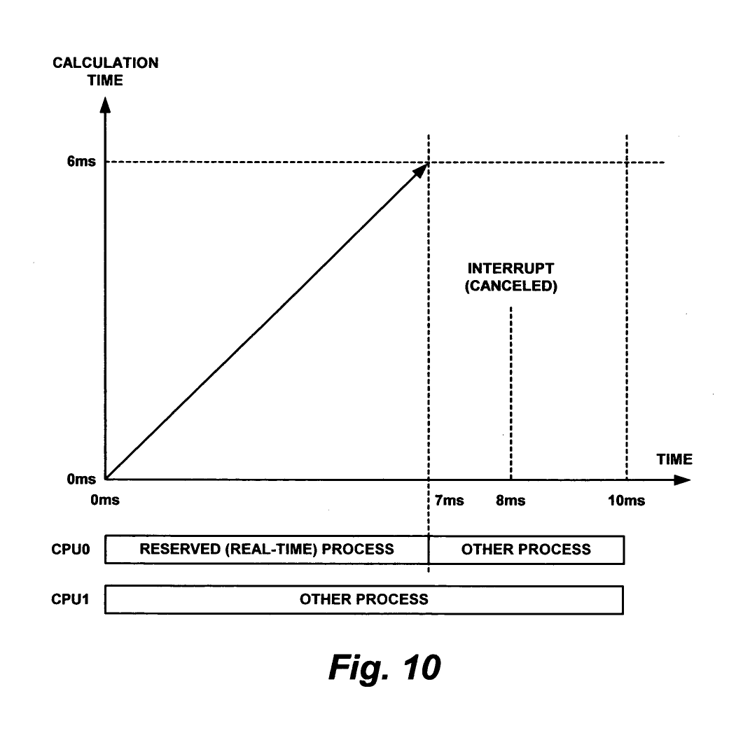

FIG. 10 is a third embodiment showing a timing of generating an interrupt when the processor that is a calculation resource carries out processing on a real-time process. As in the case of the embodiments shown in FIG. 8 and FIG. 9, the reserved process reserves a calculation time of 6 ms by the deadline after 10 ms. In the embodiment shown in FIG. 10, even if there are influences of other processes being simultaneously executed, it is guaranteed that calculation performance with a minimum guaranteed value a is obtained.

For example, when a minimum guaranteed value a is 0.5, it is guaranteed that the processor performance of 50% can always be assigned to the real-time process. As described above, a slack time of 4 ms is calculated, but the next interrupt is calculated as time 8 ms from the above described formula tₙ=[(t_{d}−t₀)−(cᵣ−c₀)]/(1−α)+t₀. This means that when the processor carries out processing using a minimum guaranteed value, the time at which the slack time becomes 0 is 8 ms. In the embodiment shown in FIG. 10, the process is completed at time 7 ms, and therefore the remaining 3 ms until the deadline can be assigned to other processes which are non-real-time processes. In this case, the interrupt is canceled, and therefore no interrupt is generated by the deadline.

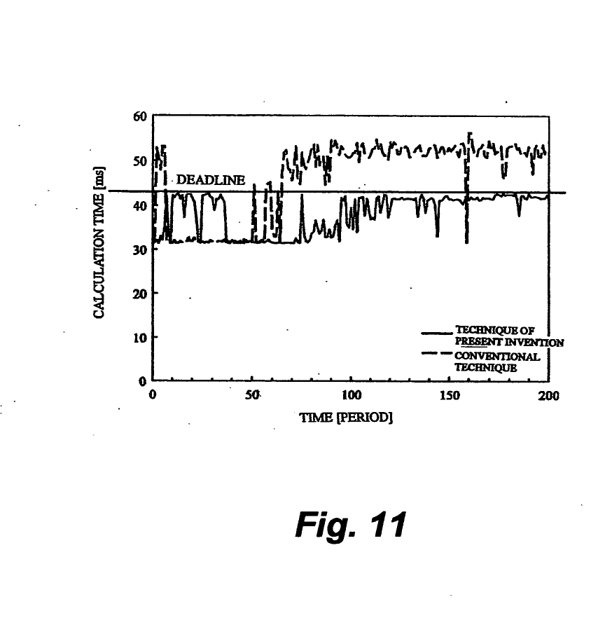

Here, FIG. 11 shows a comparison between the processing result when the system of the present invention is adopted and the processing result when a conventional system, that is, a real-time process and non-real-time process are processed simultaneously. More specifically, a case where the above-described function of the present invention is installed under the Linux and the Hyper Threading technology of Intel Corporation is compared with the case where the above-described function is not installed. Kernel compilation is used as the non-real-time process and a calculation lasting 30 ms for a period of 43.3 ms is used as the real-time process. Solid lines show the result of using the system of the present invention and the result of processing using the method of the present invention and dotted lines show the result of processing using the above described conventional method. Furthermore, FIG. 11 also shows the deadline at a calculation time of 43.3 ms on the vertical axis.

According to the result shown in FIG. 11, when the function is not installed, a real-time process and non-real-time processes are processed simultaneously on one processor, and therefore processing corresponding to 30 ms cannot be executed 43.3 ms later which is the deadline and it takes 45 ms to 55 ms to carry out the processing of 30 ms as shown by dotted lines. In contrast, with the machine in which the system of the present invention is installed, the calculation time is always below the deadline and the processing corresponding to 30 ms after 43.3 ms which is the deadline is completed and it is possible to confirm that a predetermined calculation time, that is, a predetermined amount of calculation can be obtained by the deadline.

Furthermore, when the case where the present invention system is used is compared to a conventional case where processing of a non-real-time process being in real-time process is suspended and a non-real-time process is processed after the real-time process is completed, it is possible to confirm that the amount of processing of the non-real-time process can be obtained with a throughput of a maximum of 1.9 times or at least a throughput equivalent to the conventional throughput.

The present invention has been explained using the embodiments shown in the attached drawings so far, but the present invention is not limited to the embodiments shown in the attached drawings, and it is also possible to achieve the functions of the various sections by executing a program as described above. In this case, the present invention can also be provided as a recording medium in which the program is recorded. When the present invention is provided as a recording medium, the program can be executed by the processor which is a calculation resource and the program can be provided as an interrupt handler as shown above. However, in this case, the processor executes the program to generate an interrupt, decides a slack time and suspends the non-real-time process.

Since the system of the present invention is a system that guarantees a deadline for a real-time process and at the same time processes other processes whenever possible to improve the system throughput, it is preferably used for an aircraft control system or medical system, etc., whose deadline must be strictly observed.

The foregoing description of the invention has been presented for purposes of illustration and description. It is not intended to be exhaustive or to limit the invention to the precise form disclosed, and other modifications and variations may be possible in light of the above teachings. For example, the invention may a computer program product embodied in a tangible media. The tangible media may include, but is not limited to, computer readable random access memory, read only memory, magnetic memory, optical memory and the like.

The embodiments disclosed were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A calculation resource reservation system for guaranteeing a process requesting a predetermined amount of calculation of a calculation resource that said predetermined amount of calculation is obtained by a deadline, the calculation resource configured to process a plurality of processes simultaneously, the calculating resource reservation system comprising:
a measuring section configured to measure an amount of calculation of said process obtained through calculation processing by said calculation resource;
a slack time decision section configured to generate an interrupt to the calculation processing using said calculation resource, acquire said amount of calculation acquired by an interrupt generation time from said measuring section, provide said amount of calculation acquired to said calculation resource so as to calculate a slack time and determine whether said slack time is available or not; and
a processing interruption section configured to interrupt the processing of other processes by said calculation resource if said slack time decision section determines that said slack time is not available.

2. The system according to claim 1, wherein said slack time decision section is configured to generate an interrupt at predetermined time intervals.

3. The system according to claim 1, wherein said slack time decision section comprises an interrupt generation time setting section configured to cause said calculation resource to calculate a next interrupt generation time using said slack time and said interrupt generation time and to set the next interrupt generation time so that an interrupt is generated at said next interrupt generation time.

4. The system according to claim 3, wherein said slack time decision section comprises an amount of calculation decision section configured to determine whether said predetermined amount of calculation is acquired or not before said next interrupt generation time.

5. The system according to claim 1, wherein said system comprises a storage section configured to store contexts of said other processes interrupted by said processing interruption section.

6. The system according to claim 1, wherein said slack time tₛ is calculated using said deadline t_{d}, said interrupt generation time t₀, value cᵣ which is said predetermined amount of calculation represented by a calculation time when there is no influence of a back processor thread and value c₀ which is an amount of calculation measured at said interrupt generation time represented by a calculation time when there is no influence of the back processor thread, according to the formula: tₛ=(t_{d}−t₀)−(cᵣ−c₀).

7. The system according to claim 3, wherein said next interrupt generation time tₙ is calculated using said deadline t_{d}, said interrupt generation time t₀, value cᵣ which is said predetermined amount of calculation represented by a calculation time when there is no influence of a back processor thread and value c₀ which is an amount of calculation measured at said interrupt generation time represented by a calculation time when there is no influence of the back processor thread, according to the formula, tₙ=(t_{d}−t₀)−(cᵣ−c₀)+t₀.

8. The system according to claim 3, wherein said next interrupt generation time tₙ is calculated using said deadline t_{d}, said interrupt generation time t₀, value cᵣ which is said predetermined amount of calculation represented by a calculation time when there is no influence of a back processor thread, value c₀ which is an amount of calculation measured at said interrupt generation time represented by a calculation time when there is no influence of the back processor thread and a minimum guaranteed value α (α is a number greater than or equals to 0 and smaller than 1) of calculation performance obtained even when said calculation resource is assigned to said other processes, according to the formula, tₙ=[(t_{d}−t₀)−(cᵣ−c₀)]/(1−α)+t₀.

9. A calculation resource reservation method for guaranteeing a process requesting a predetermined amount of calculation of a calculation resource that said predetermined amount of calculation is obtained by a deadline, the calculation resource configured to process a plurality of processes simultaneously, the method comprising:
measuring an amount of calculation of said process obtained through calculation processing by said calculation resource;
generating an interrupt to the calculation processing using said calculation resource and acquiring said amount of calculation acquired by an interrupt generation time;
providing said amount of calculation acquired to said calculation resource so as to calculate a slack time and determining whether said slack time is available or not; and
interrupting the processing of other processes by said calculation resource if said slack time is not available.

10. The method according to claim 9, wherein in said operation of acquiring said amount of calculation, an interrupt is generated at predetermined time intervals.

11. The method according to claim 9, wherein said method includes causing said calculation resource to calculate a next interrupt generation time using said slack time and said interrupt generation time and setting the next interrupt generation time so that an interrupt is generated at said next interrupt generation time.

12. The method according to claim 11, wherein said method includes deciding whether said predetermined amount of calculation is acquired or not before said next interrupt generation time.

13. The method according to claim 9, wherein said method includes storing contexts of said other processes interrupted by said processing interruption section.

14. The method according to claim 9, wherein said slack time tₛ is calculated using said deadline t_{d}, said interrupt generation time t₀, value cᵣ which is said predetermined amount of calculation represented by a calculation time when there is no influence of a back processor thread and value c₀ which is an amount of calculation measured at said interrupt generation time represented by a calculation time when there is no influence of the back processor thread, according to the formula, tₛ=(t_{d}−t₀)−(cᵣ−c₀).

15. The method according to claim 11, wherein said next interrupt generation time tₙ is calculated using said deadline t_{d}, said interrupt generation time t₀, value cᵣ which is said predetermined amount of calculation represented by a calculation time when there is no influence of a back processor thread and value c₀ which is an amount of calculation measured at said interrupt generation time represented by a calculation time when there is no influence of the back processor thread, according to the formula, tₙ=(t_{d}−t₀)−(cᵣ−c₀)+t₀.

16. The method according to claim 11, wherein said next interrupt generation time tₙ is calculated using said deadline t_{d}, said interrupt generation time t₀, value cᵣ which is said predetermined amount of calculation represented by a calculation time when there is no influence of a back processor thread, value c₀ which is an amount of calculation measured at said interrupt generation time represented by a calculation time when there is no influence of the back processor thread and a minimum guaranteed value α (α is a number greater than or equals to 0 and smaller than 1) of calculation performance obtained even when said calculation resource is assigned to said other processes, according to the formula, tₙ[(t_{d}−t₀)−(cᵣ−c₀)]/(1−α)+t₀.

17. A computer program product embodied in a tangible media comprising:
computer readable program codes coupled to the tangible media for guaranteeing a process requesting a predetermined amount of calculation of a calculation resource that said predetermined amount of calculation is obtained by a deadline, the calculation resource configured to process a plurality of processes simultaneously, the computer readable program codes configured to cause the program to:
measure an amount of calculation of said process obtained through calculation processing by said calculation resource;
generate an interrupt to the calculation processing and acquire said amount of calculation acquired by the interrupt generation time;
calculate a slack time using said amount of calculation acquired and determine whether said slack time is available or not; and
interrupt the processing of other processes by said calculation resource if said slack time is not available.

18. The computer program product according to claim 17, wherein during said computer readable program code configured to acquire said amount of calculation, an interrupt is generated at predetermined time intervals.

19. The computer program product according to claim 17, further comprising computer readable program code configured to cause said calculation resource to calculate a next interrupt generation time using said slack time and said interrupt generation time and set the next interrupt generation time so that an interrupt is generated at said next interrupt generation time.

20. The computer program product according to claim 19, further comprising computer readable program code configured to determine whether said predetermined amount of calculation is acquired or not before said next interrupt generation time.

21. The computer program product according to claim 17, further comprising computer readable program code configured to store contexts of said other processes interrupted by said processing interruption section.

22. The computer program product according to claim 17, wherein said slack time tₛ is calculated using said deadline t_{d}, said interrupt generation time t₀, value cᵣ which is said predetermined amount of calculation represented by a calculation time when there is no influence of a back processor thread and value c₀ which is an amount of calculation measured at said interrupt generation time represented by a calculation time when there is no influence of the back processor thread, according to the formula, tₛ=(t_{d}−t₀)−(cᵣ−c₀).

23. The computer program product according to claim 19, wherein said next interrupt generation time tₙ is calculated using said deadline t_{d}, said interrupt generation time t₀, value cᵣ which is said predetermined amount of calculation represented by a calculation time when there is no influence of a back processor thread and value c₀ which is an amount of calculation measured at said interrupt generation time represented by a calculation time when there is no influence of the back processor thread, according to the formula, tₙ=(t_{d}−t₀)−(cᵣ−c₀)+t₀.

24. The computer program product according to claim 19, wherein said next interrupt generation time tₙ is calculated using said deadline t_{d}, said interrupt generation time t₀, value cᵣ which is said predetermined amount of calculation represented by a calculation time when there is no influence of a back processor thread, value c₀ which is an amount of calculation measured at said interrupt generation time represented by a calculation time when there is no influence of the back processor thread and a minimum guaranteed value α (α is a number greater than or equals to 0 and smaller than 1) of calculation performance obtained even when said calculation resource is assigned to said other processes, according to the formula, tₙ=[(t_{d}−t₀)−(cᵣ−c₀)]/(1−α)+t₀.
